(19) United States
(12) Patent Application Publication
(10) Pub. No.: US 2007/0010904 A1
(43) Pub. Date: Jan. 11, 2007

(54) Method and system for estimating order scheduling rate and fill rate for configured-to-order business

(76) Inventors: Feng Cheng, Chappaqua, NY (US); Thomas Robert Ervolina, Poughquag, NY (US); Soumyadip Ghosh, New York, NY (US); Barun Gupta, Seymour, CT (US); Young Min Lee, Westbury, NY (US)

Correspondence Address: Whitham, Curtis & Christofferson, P.C., Suite 340, 11491 Sunset Hills Road, Reston, VA, 20190, US

(21) Appl. No.: 11/176,311

(22) Filed: Jul. 8, 2005

(51) Int. Cl. G06F 19/00

(52) U.S. Cl. 700/97; 700/99; 700/100

(57) ABSTRACT

A system and method estimates performance of a supply chain's available-to-promise (ATP) and scheduling functions under various environmental and process assumptions. The supply chain's transformation alternatives are identified using a plurality of modules constituting a supply chain model and including a demand planning module, a configuration planning module, an order scheduling module and a supply planning module, each of said modules being reconfigurable using various policies, which policies, taken together, specify a particular supply chain design that is to be analyzed. A supply chain data base is accessed by the supply chain model to retrieve data elements that dictate appropriate policies within said plurality of modules. The supply chain performance is simulated based on settings of the modules and other environmental factors including demand uncertainty, order configuration uncertainty, supplier flexibility, supply capacity, and demand skew. Based on the simulation, scheduling and fill rate of new business settings are evaluated to determine if improvements to the supply chain are satisfactory.

### BACKGROUND OF THE INVENTION

1. Field of the Invention

The present invention is generally related to supply chain analysis and, more particularly, to a method and system for estimating order scheduling rate and fill rate for configured-to-order business where both products and product recipes are forecasted.

2. Background Description

Most supply chain performance analysis has been typically conducted within a sub-process, such as demand planning, supply planning or order scheduling, in isolation. However, in practice, the combined effect of various sub-processes affects the supply chain performance. It is difficult to estimate the system performance by separately analyzing each sub-process in isolation. For many companies, the only way to estimate the performance of new supply chain design is to put it in production and measure it from there. But if the design is flawed, the time it takes to re-engineer can take months or years and is very costly (both in labor and in opportunity cost of poor supply chain practice).

### SUMMARY OF THE INVENTION

According to the invention, there is provided a method and system for estimating the performance of a supply chain's available-to-promise (ATP) and scheduling functions under various environmental and process assumptions. Using the system, it is possible to analyze various configurations of demand planning, ATP generation, and order scheduling for complex configured products. The system comprises various modules including a demand planning module, an order scheduling module, and a supply planning module. Each module can be reconfigured using various policies. The policies define business rules and system configurations which, together, specify the particular supply chain design that is to be analyzed. The system also contains a simulator, which simulates the supply chain performance based on the settings of the modules and other environmental factors such as demand uncertainty, order configuration uncertainty, supplier flexibility, supply capacity, and demand skew.

A key feature of the invention is that supply chain performance depends on how the individual policies of each sub-process work through an integrated process. With this invention, the supply chain design can be tested and refined in a laboratory environment before going into production. The aim is to get it right the first time.

The invention can also be used to study an existing supply chain design to see if performance can be improved through policy modification. The invention can also be used to test how a given supply chain design will perform under different environments. For example, if business environment is tending towards tighter capacity, or greater uncertainty, how would the supply chain perform? While most simulation systems can run with only mocked-up data, the system according to this invention can run with production data and can scale to large data sets.

A further use of the invention is to analyze the supply chain performance under different product design scenarios. These scenarios might include moving to more common parts versus unique features, or more models with less configuration options versus less models with many configuration choices.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating the system which implements the simulation method for estimating order scheduling and fill rate according to the invention; and

FIG. 2 is a flow diagram illustrating the logic of the business process that uses method implemented on the system shown in FIG. 1.

### DETAILED DESCRIPTION OF A PREFERRED EMBODIMENT OF THE INVENTION

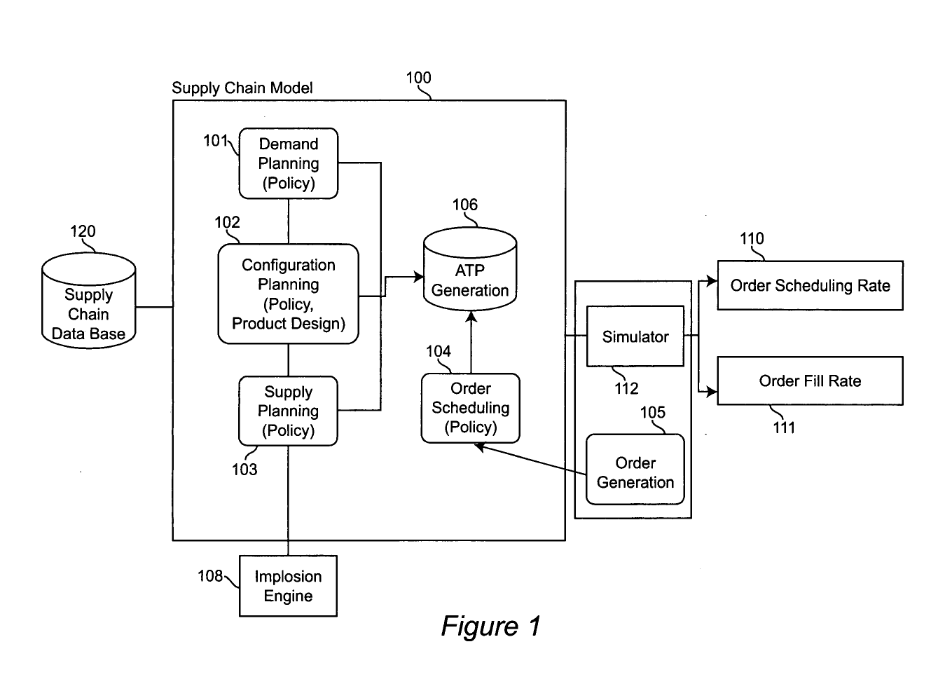

FIG. 1 is a block diagram illustrating the system which implements the method for estimating order scheduling rate and order fill rate for CTO (Configured-to-Order) business. The order scheduling rate here is defined as percentage of customer orders that are assigned and communicated scheduled ship dates. The customers typically request when they would like to receive the products that they are ordering. Depending on the availability of finished products and components, the scheduled ship date of the order is designated to be same as the customer requested date or later. The order scheduling rate reflects the percentage of customer orders that may not be automatically scheduled within certain scheduling horizon in the system. The order fill rate is defined here as the percentage of scheduled orders that are filled on the scheduled date.

The Supply Chain model 100 is a process of a CTO supply chain, where customer orders are processed and fulfilled. This model consists of four modules; Demand Planning 101, Configuration Planning 102, Supply Planning 103, and Order Scheduling 104. Each of these modules contains various policies that can be reconfigured as per the current business being studied. The Supply Chain Data Base 120 is a corporate data repository that contains various data elements that dictate the appropriate policies within the modules of the model.

The Demand Planning module 101 contains information on projected future sales of products. This forecast demand information can be at the finished goods level or components which constitute the finished products. The demand forecast is typically modeled in weekly buckets over a planning horizon of three months, based on the trend observed in the past business transaction data. The uncertainty of demand forecast is modeled by an aptly chosen probability distribution function. The policy within this module sets demand planning options such as the parameters of the uncertainty distribution, a flag that indicates forecast requirement at the finished products level or components level, etc.

The Configuration Planning module 102 contains information on anticipated usage of specific components when finished products are configured by customers. It provides (fractional) usage rates called feature ratio or Attach Rates, which are forecast based on past history of finished goods demand and supply. The uncertainty of configuration is modeled using appropriate probability distribution functions. The policy governing this configuration planning dictates the product structure of the model. A business may be interested in evaluating the impact of various alternatives of product structures; for example, moving to more common parts vs. unique features; less configuration options vs. more configuration options, etc.

The Supply Planning module 103 contains information on supply commitment from components suppliers. The required quantities of components are computed by the Implosion Engine 108, which uses the component Attach Rates and other business rules in the computation. The uncertainty of supplier commitment is modeled using a probability distribution function. Applying this uncertainty gives the supplier commitments for the components. Form this the Supply Planning module computes the projected availability of finished products with respect to weekly buckets into the future, again by calling the Implosion Engine 108 with the appropriate parameters. This availability quantity is known as ATP (Available-to-Promise) quantity. The policy in this module governs how uncertain and flexible the suppliers' responses are, and capture the supply situation faces by the business in sufficient detail.

The Order Scheduling module 104 processes each customer order, and schedules a ship date based on the expected availability 106 of products or components. When an order is scheduled against the ATP, the specific quantity of the product or components are reserved for the particular order so that other future customer order cannot use this availability. The products and components are available with respect to time (daily or weekly time bucket etc.) and geographic location of the availability. The simulation model uses various scheduling policies to decide from which time-bucket availability it is going reserve product and components for each order. The availability reservation policies can depend on types of customer and geographic locations where the order is placed, and the sales price/profit margin of products.

The simulator 112 is connected with all the modules of the supply chain model 100. It drives the model with the random numbers specified by various probability distribution functions described above. The Order Generation module 105 produces customer orders using a probabilistic model that is consistent with the historic information made available to the various planning modules. The simulator 112 also coordinates the generations of events and movements of information entity such as customer orders into various modules. In a specific implementation of the invention, IBM's WBI Modeler simulation engine was used.

The simulator 112 runs the supply chain model 100 for certain duration of simulated time, for example for three months, one year or few years, as specified by the modeler. And during the time period, it simulates various planning, order scheduling and order processing activities as dictated in the supply chain model 100 in FIG. 1. As each order is created and processed in the various tasks, and scheduled, the order is attached with information on schedule date and fulfilled date as well as customer requested ship date. During the simulation run, the availability quantities for all the finished products and components are also recorded. At the end of simulation runs, simulator summaries the overall order scheduling rate 110, order fill rate 111 as well as ATP profiles of all the finished products and components.

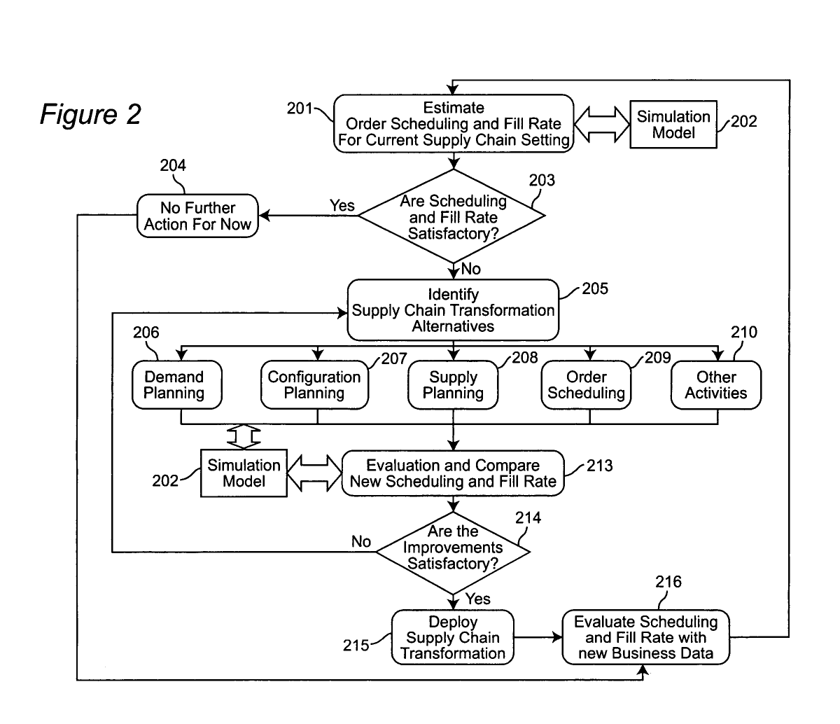

FIG. 2 is a flowchart illustrating a business process that uses the method of estimating order scheduling rate and fill rate described in the previous section. Although the business process described here is a specific supply chain process for a computer hardware business within in IBM, the method can also be used in many other supply chain processes in various businesses.

The first step 201 is to estimate Order Scheduling Rate and Fill Rate for existing business setting. The estimation is computed by running the simulation model 202. Note that the model 202 in FIG. 2 is the same supply chain model shown as 100 in FIG. 1. The next step 203 is to evaluate whether the order scheduling and fill rate in the current business environment are satisfactory. In this step the business analysts may consult the customer service department, review current service level agreements for customers, and compare the customer service level of other competitor companies. If the current performance metrics are within the satisfactory range, no further action is taken 204 until a new evaluation is called in the future with new business setting and data 216. If the current scheduling and fill rate are not satisfactory, one or more of modules within the simulation model 100 are reconfigured for new simulation runs. The modules that can be updated here are Demand Planning 206, Configuration Planning 207, Supply Planning 208, Order Scheduling 209, and they are same as the modules described in the FIG. 1 (101, 102, 103 and 104, respectively). There can also be other sub-processes 210 that can be modified depending on the business process. The changes in supply chain can also be in product structure and various planning/scheduling policies 211. For example, a modeler may change the order scheduling policy from Finished Product-based scheduling to Component-based scheduling, or increase the supply planning frequencies, etc. This information is supplied to the simulation model 100 through the Supply Chain Database 120.

Once the supply chain transformation alternatives are set, the simulation model 202 runs again to estimate the scheduling and fill rate of the new business setting 213. If the improvements are satisfactory 214, the changes can be deployed in the business 215.

Once new changes in supply chain have been implemented for a certain period of time, business analysts may want to re-evaluate 216, 201 the Order Scheduling and Fill Rate with the new business data. This would form a closed-loop process, which promotes a continuous business improvement.

From the foregoing, it will be appreciated that the invention provides a novel way to analyze how various sub-processes of supply chain, from demand planning to configuration planning, supply planning, order scheduling, together as an integrated process, affect supply chain performance. The invention can also be used to analyze emerging supply chain designs. Thus, while the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A system for estimating performance of a supply chain's available-to-promise (ATP) and scheduling functions under various environmental and process assumptions, comprising:
a plurality of modules constituting a supply chain model and including a demand planning module, a configuration planning module, an order scheduling module and a supply planning module, each of said modules being reconfigurable using various policies, which policies, taken together, specify a particular supply chain design that is to be analyzed;
a supply chain database accessed by said supply chain model and containing data elements that dictate appropriate policies within said plurality of modules; and
a simulator connected to each of the plurality of modules of the supply chain model which simulates the supply chain performance based on settings of the modules and other environmental factors including demand uncertainty, order configuration uncertainty, supplier flexibility, supply capacity, and demand skew.

2. The system of claim 1, wherein the demand planning module contains information on projected future sales of products modeled in predetermined time periods over a planning horizon based on a trend observed in past business transaction data, a policy within the demand planning module setting demand planning options and uncertainty of demand forecast being modeled by a probability distribution function.

3. The system of claim 1, wherein the configuration planning module contains information on anticipated usage of specific components when finished products are configured by customers and provides usage rates forecast based on past history of finished goods demand and distribution functions, a policy within the configuration planning module dictating product structure of the model.

4. The system of claim 1, wherein the supply planning module contains information on supply commitment from components suppliers, required quantities of components being computed by an implosion engine which uses business rules in its computation and uncertainty of supplier commitment being modeled using a probability distribution function.

5. The system of claim 1, wherein the order scheduling module processes each customer order and schedules a ship date based on expected availability of products or components.

6. The system of claim 1, wherein
the demand planning module contains information on projected future sales of products modeled in predetermined time periods over a planning horizon based on a trend observed in past business transaction data, a policy within the demand planning module setting demand planning options and uncertainty of demand forecast being modeled by a probability distribution function,
the configuration planning module contains information on anticipated usage of specific components when finished products are configured by customers and provides usage rates forecast based on past history of finished goods demand and distribution functions, a policy within the configuration planning module dictating product structure of the model,
the supply planning module contains information on supply commitment from components suppliers, required quantities of components being computed by an implosion engine which uses business rules in its computation and uncertainty of supplier commitment being modeled using a probability distribution function, and
the order scheduling module processes each customer order and schedules a ship date based on expected availability of products or components.

7. The system of claim 1, wherein the simulator runs the supply chain model for a predetermined duration of simulated time and during the simulated time simulates various planning, order scheduling and order processing activities as dictated by the policies implemented in the supply chain model.

8. A method for estimating performance of a supply chain's available-to-promise (ATP) and scheduling functions under various environmental and process assumptions, comprising the steps of:
identifying the supply chain's transformation alternatives using a plurality of modules constituting a supply chain model and including a demand planning module, a configuration planning module, an order scheduling module and a supply planning module, each of said modules being reconfigurable using various policies, which policies, taken together, specify a particular supply chain design that is to be analyzed;
accessing a supply chain database by said supply chain model to retrieve data elements that dictate appropriate policies within said plurality of modules;
simulating the supply chain performance based on settings of the modules and other environmental factors including demand uncertainty, order configuration uncertainty, supplier flexibility, supply capacity, and demand skew; and
evaluating scheduling and fill rate of new business settings to determine if improvements to the supply chain are satisfactory.
